(19) United States
(12) Patent Application Publication
(10) Pub. No.: US 2015/0185134 A1
(43) Pub. Date: Jul. 2, 2015

(54) System and Apparatus of Electrochemical Sensor Embedded RFID for Corrosion Detection and Monitoring

(71) Applicants: Thomas C. H. Chen, Houston, TX (US); Hamid Parsaei, League City, TX (US)

(72) Inventors: Thomas C. H. Chen, Houston, TX (US); Hamid Parsaei, League City, TX (US)

(21) Appl. No.: 14/144,936

(22) Filed: Dec. 31, 2013

(51) Int. Cl. G01N 17/02; G06K 19/07; G06K 7/10; G01N 27/26

(52) U.S. Cl. CPC G01N 17/02; G01N 27/26; G06K 19/0717; G06K 7/10366

(57) ABSTRACT

An electrochemical sensor embedded RFID system that uses electrochemical sensor embedded RFID tags, RFID readers, intelligent-agent-based software, wireless and landline communication networks, and Internet, Intranet, Extranet links for continually identifying, sensing, aggregating, monitoring, tracking and networking of multiple clusters of metal objects. The electrochemical sensor embedded RFID system comprises a plurality of electrochemical sensor embedded RFID tag apparatus for identifying, sensing and measuring metal object's corrosion conditions, and a plurality of RFID reader apparatus which containing system software that uses an active, real-time concurrent method to process metal object's corrosion, conditions along with location information to be transmitted to a cloud-based remote monitoring station. The electrochemical sensors embedded RFID tags can be attached to metal objects located at corrosion prone areas to form an Internet-linked RFID sensor network for providing metal structure corrosion alters to end-user from anywhere at anytime.

### BACKGROUND

1. Field of Invention

This invention relates in general to Radio-Frequency Identification (RFID) system, and in particular to an electrochemical sensor embedded RFID system that can be used for detecting and monitoring metal structure corrosion.

2. Description of Related Art

Corrosion is degradation of materials' properties due to interactions with their environments. The corrosion process is usually electrochemical in nature and commonly occurs because unstable materials, such as refined metals want to return to a more stable compound. A wide variety of corrosion detection and monitoring methods exists, such as weight loss coupons, electrical resistance, linear polarization, hydrogen penetration, and galvanic current. The corrosion monitoring method of this invention is based on the measurement of electrochemical process in-progress on metal objects through continuous readings of electrochemical sensors attached on those metal objects.

Different electrochemical sensor for corrosion monitoring had been disclosed in the related art. For example, U.S. application Ser. No. 60/545,038 to Chester M. Dacres and Guy D. Davis describes a hand-held and flexible corrosion sensor that uses electrochemical impedance spectroscopy to detect coating degradation and corrosion of coated and uncoated metals. In another example, U.S. Pat. No. 6,683,463 to Lietai Yang and Narasi Sridhar reveals a sensor array for measuring localized corrosion based on electrochemical reactions. The sensor has an army of electrodes that are made from the material of interest. In another example, U.S. Pat. No. 8,451,124 to Jerome P. Lynch et al. reveals a method for sensing a stimulus comprising a sensing assembly having a first structure and a second structure, wherein the first structure is made of a material different than the second structure and each of the first structure and the second structure is nanoscale. Another relevant example is U.S. Pat. No. 8,357,958 to Timothy Cummins that explains a single chip wireless sensor comprises a microcontroller connected to a transmit/receive interface, which is coupled to a wireless antenna by an L-C matching circuit. In other examples, U.S. Pat. No. 8,313,434 to Mark Brister et al. discusses systems and methods for measuring an analyte in a host and associated methods of manufacture. In another example, U.S. Pat. No. 8,348,504 to Otto J. Gregory et al. reveals a temperature measurement system capable of operating in harsh environments including a temperature sensor having an antenna, diode, and dielectric layer disposed on the object of interest.

Many sensor integrated RFID systems have also been discussed in the prior art. For example, U.S. Pat. No. 8,358,210 to Timothy T. Goodnow, and Lei He describes a glucose monitoring system, includes a glucose sensor strip or package of strips. The strip includes a substrate and a glucose monitoring circuit that has electrodes and a bodily fluid application portion of selected chemical composition. In other examples, U.S. Pat. No. 8,436,619 to Kevin I. Bertness and John S. Philbrook discusses a combined sensing, and reading apparatus which includes a tag reader and an environment sensor integrated with the tag reader. Another example, U.S. Pat. No. 8,339,219, Jack L. Skinner et al. describes the integration of surface acoustic wave (SAW) filters, microfabricated transmission lines, and sensors onto polymer substrates in order to enable a passive wireless sensor platform. Another relevant example is U.S. Pat. No. 8,248,249 to Jean-Yves Clement et al. that explains RFID tag and a system and method involving a plurality of RFID tags and each RFID tag is attached to an object on which the presence of a predefined fluid is monitored. In another example, U.S. Pat. No. 8,394,246 to Michael J. Celentano, P. and Douglas Walling explains a remote measurement system measures the concentrations of analytes in fluid samples. The system includes a metering device that can receive signals from a test strip or alternatively interrogate the test strip to obtain information.

RFID readers, RFID tags, sensors and related systems mentioned in the above patents have limitations of a) it has relatively limited reading range, b) it cannot process identification and sensor data concurrently in an effective manner, c) it does not use Internet, Web and cloud computing technologies for storing and sharing of RFID and sensor data so that those data can be accessed from anywhere at anytime, d) it lacks data aggregation, capability to avoid information overload of huge sensor data when monitoring in real-time.

To overcome above-mentioned limitation, a need exists for a sensor embedded RFID system that includes multiple RFID readers, electrochemical sensor embedded RFID tags, intelligent-agent based software, wireless communication networks, Internet, Intranet, and Extranet links which can process identification, sensing, and aggregating data concurrently, and has wireless communication capabilities among readers, tags and sensors for locating and tracking objects and exchanging data/information among all interested parties.

### OBJECTS AND ADVANTAGES

It is therefore an object of this invention to provide an electrochemical sensor embedded RFID system that includes electrochemical sensor embedded RFID tags which contain circuitry for identifying, sensing and measuring electrochemical parameters surrounding of electrochemical sensor embedded RFID tags.

Another object of the invention is to provide an electrochemical sensor embedded RFID system that includes RFID readers, which have a signal strength measurement capability. Multiple antennas located at different positions and attached to the same RFID reader, can measure signal strength transmitted from a single electrochemical sensor embedded RFID tag. The signal strength information can be used by a remote location server to calculate electrochemical sensor embedded RFID tag's location through multiple signal triangulation.

Another object of this invention is to provide an electrochemical sensor embedded RFID system that can process multiple wireless RFID/sensor communication protocols. These multiple wireless RFID/sensor communication protocols might include reader-talk-first mode, tag-talk-first mode, EPC (Electronic Product Code)-compatible protocol mode, and Non-EPC compatible protocol mode, and are processed/communicated among RFID readers and electrochemical sensor embedded RFID tags.

Another object of this invention is to provide an electrochemical sensor embedded RFID system that includes RFID readers which contain both landline communication and wireless LAN communication modules to be used either at stationary or mobile position. Stationary RFID readers are used to detect objects resided a stationary point, while mobile readers attached to a moving vehicle or device, are used to read electrochemical sensor embedded RFID tags within the RF reading range of moving path. A real-time location trackable RFID system requires a joint operation of both stationary and mobile RFID readers. To meet these communication needs, a preferred RFID reader shall have external communication links that include both landline communication modules such as USB, or RS232, RS485, and wireless communication modules such as 802.11, 802.15, Bluetooth, or cellular communication network.

Further object of the invention is to provide an electrochemical sensor embedded RFID system that includes RFID readers, which contain both wireless Web server and Web client. This object allows concurrent communication and information exchange among RFID readers and electrochemical sensor embedded RFID tags. The Web server uses a Hypertext Transmission Protocol (HTTP) to communicate with other RFID readers through landline communication or wireless LAN communication. This preferred RFID reader, with embedded Web server and Web client, also allows reader to be reconfigured from a remote server regarding transmitting/receiving frequencies, communication protocols, or external communication links. It also allows data collected by RFID readers to be accessible by remote clients using a standard internet browser at anytime and anywhere.

Another object of the invention is to provide an electrochemical sensor embedded RFID system that includes RFID readers which include an intelligent controller and a plurality of task shared memory to administrate and manage all related application tasks simultaneously. An intelligent controller is responsible for starting and stopping all related application tasks by using the information stored in task shared memory. The intelligent controller is also responsible for installing new application tasks and uninstalling existing application tasks at runtime. The execution of the intelligent controller and all other related application tasks are running under separate parallel execution threads concurrently to fully utilize system's processing power.

It is another object of this invention is to provide an electrochemical sensor embedded RFID system that allows identification, sensing and location data from electrochemical sensor embedded RFID tags to be shared and exchanged at a remote location. Through Internet, Intranet, Extranet, links, and a Web-based RFID/sensor data exchange and collaboration system, these information can be accessed by all interested parties, anywhere and anytime, around the world.

### BRIEF DESCRIPTION OF THE DRAWINGS

For a further understanding of the objects and advantages of the present invention, references should be made to the following drawings in conjunction with the accompanying descriptions and operations, wherein:

FIG. 1 is an illustrative block diagram of electrochemical sensor embedded RFID tag apparatus of the electrochemical sensor embedded RFID system of this invention;

FIG. 2 is an illustrative block diagram of electrochemical sensor module of the electrochemical sensor embedded RFID tag apparatus of this invention;

FIG. 3 is an illustrative diagram of inside view of corrosion resistant housing for electrochemical sensor embedded RFID tag apparatus of the electrochemical sensor embedded RFID system of this invention;

FIG. 4 is an illustrative diagram of outside view of corrosion resistant housing for electrochemical sensor embedded RFID tag apparatus of the electrochemical sensor embedded RFID system of this invention;

FIG. 5 is an illustrative diagram of side view of corrosion resistant housing for electrochemical sensor embedded RFID tag apparatus of the electrochemical sensor embedded RFID system of this invention;

FIG. 6 is an illustrative block diagram of the RFID reader apparatus of the electrochemical sensor embedded RFID system of this invention;

FIG. 7 is an illustrative block diagram of the system software of the electrochemical sensor embedded RFID system of this invention;

FIG. 8 is an illustrative diagram of the metal tube attached with a plurality of electrochemical sensor embedded RFID tag apparatus of the electrochemical sensor embedded RFID system of this invention;

FIG. 9 is an illustrative diagram of one application view of the electrochemical sensor embedded RFID system of this invention;

FIG. 10 is an illustrative diagram of another application view using multiple stationary and mobile RFID readers of the electrochemical sensor embedded RFID system of this invention;

FIG. 11 is an illustrative diagram of the intelligent RFID/sensor data monitoring and tracking system for monitoring external corrosion of oil and natural gas pipeline of the electrochemical sensor embedded RFID system of this invention;

FIG. 12 is an illustrates diagram of the display panel of the intelligent RFID/sensor data monitoring and tracking system for monitoring external corrosion of oil and natural gas pipeline of the electrochemical sensor embedded RFID system of this invention;

### SUMMARY

An electrochemical sensor embedded RFID system that uses electrochemical sensor embedded RFID tags, RFID readers, intelligent-agent-based software, wireless and landline communication networks, and Internet, Intranet, Extranet links for continually identifying, sensing, aggregating, monitoring, tracking and networking of multiple clusters of metal objects. The electrochemical sensor embedded RFID system comprises a plurality of electrochemical sensor embedded RFID tag apparatus 100 for identifying, sensing and measuring metal object's corrosion conditions, and a plurality of RFID reader apparatus 200 which containing a system software 300 that uses an active, real-time concurrent method to process metal object's corrosion conditions along with location information to be transmitted to a cloud-based remote monitoring station. The electrochemical sensors embedded RFID tags can be attached to metal objects located at corrosion prone areas to form an Internet-linked RFID sensor network for providing metal structure corrosion alters to end-user from anywhere at anytime.

### PREFERRED EMBODIMENT—DESCRIPTION

The electrochemical sensor embedded RFID system comprises a plurality of Electrochemical Sensor Embedded RFID Tag Apparatus 100 for identify, sensing and measuring physical parameters of metal objects attached with Electrochemical Sensor Embedded RFID Tag Apparatus 100, and a plurality of RFID Reader Apparatus 200 which contains a System Software 300 that uses an active, real-time monitoring method to process object's conditions and location information to provide an alert that can be transmitted to a remote monitoring station for immediate attention.

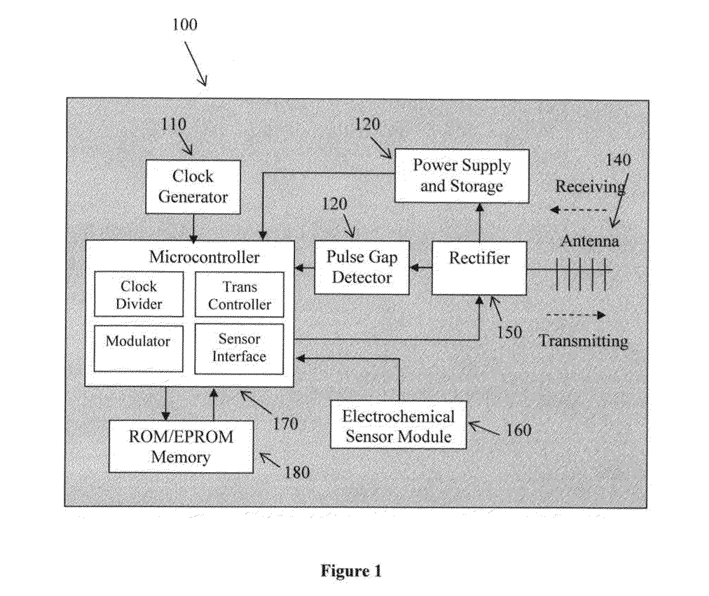

FIG. 1 shows the components of the Electrochemical Sensor Embedded RFID Tag Apparatus 100 of the electrochemical sensor embedded RFID system of this invention. Main component of the Electrochemical Sensor Embedded RFID Tag Apparatus 100 is Microcontroller 170, which is connected to Clock Generator 110, Pulse Gap Detector 120, ROM/EPROM Memory 180. Microcontroller 170 is also connected to a Electrochemical Sensor Module 160 and Electrochemical Sensor 160. Rectifier 150 is connected to Pulse Cap Detector 120, Power Supply and Storage 120. Rectifier 150 is connected to RFID/Sensor Antenna 140, and means for conducting two-way wireless communication between RFID reader and electrochemical sensor embedded RFID tag. It also means for receiving electric induction power from remote RFID reader.

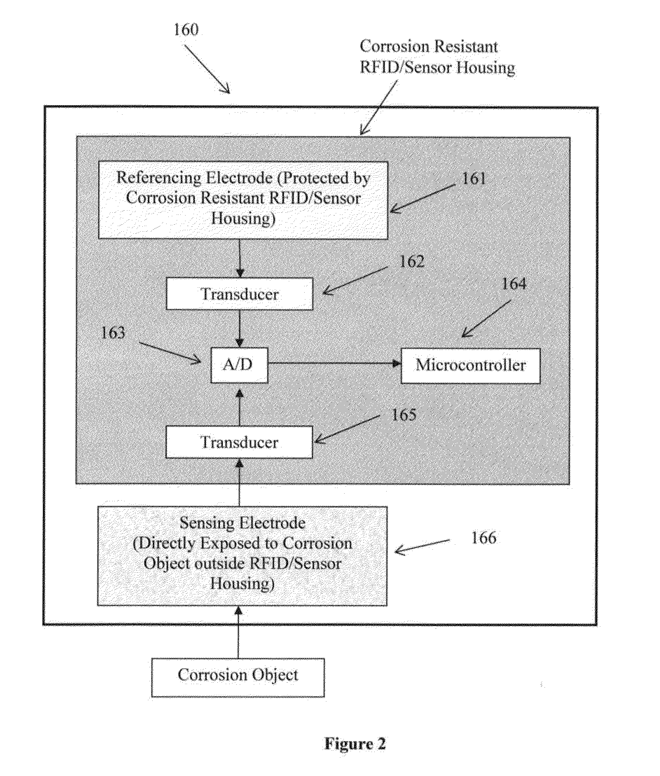

FIG. 2 shows the components of the Electrochemical Sensor Module 160 of electrochemical sensor embedded RFID system of this invention. Main component of the Electrochemical Sensor Module 160 is Referencing Electrode 161 resided inside a corrosion resistant housing, which is connected to Transducer 162. The other component of the Electrochemical Sensor Module 160 is Sensing Electrode 166 resided outside a corrosion resistant housing, which is connected to Transducer 165. Transducer 162 and Transducer 165 are connected to an Analog-to-Digital Converter (A/D) 163, which sends digital sensor data to Microcontroller 164 for processing.

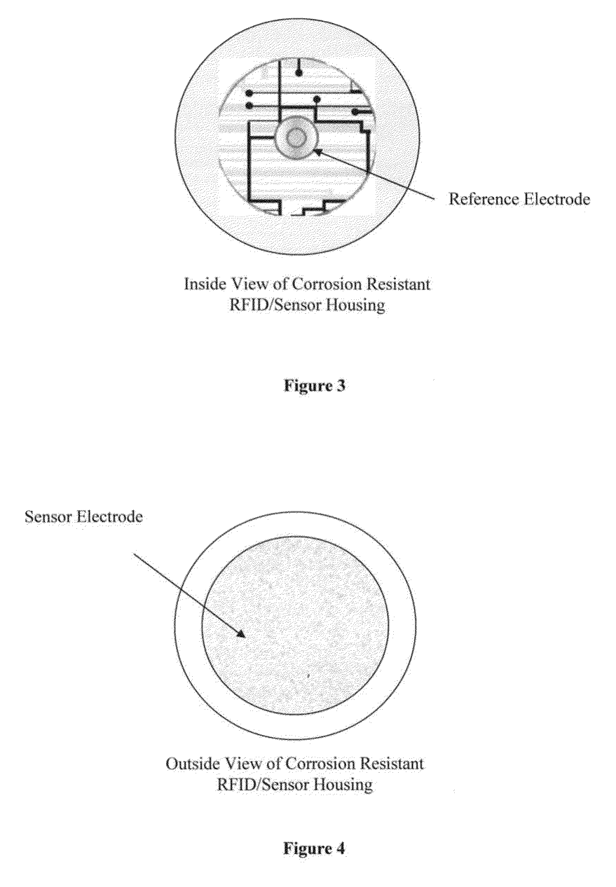

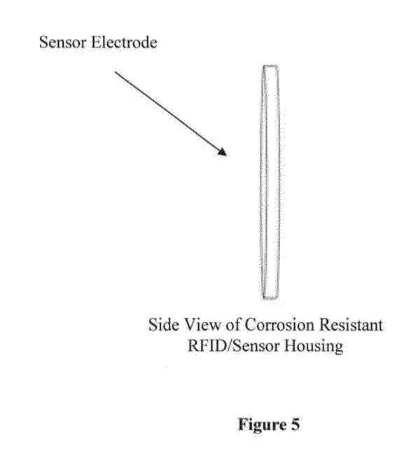

FIG. 3, FIG. 4 and FIG. 5 shows inside, outside, and side view of corrosion resistant housing that is used to house various components of Electrochemical Sensor Module 160.

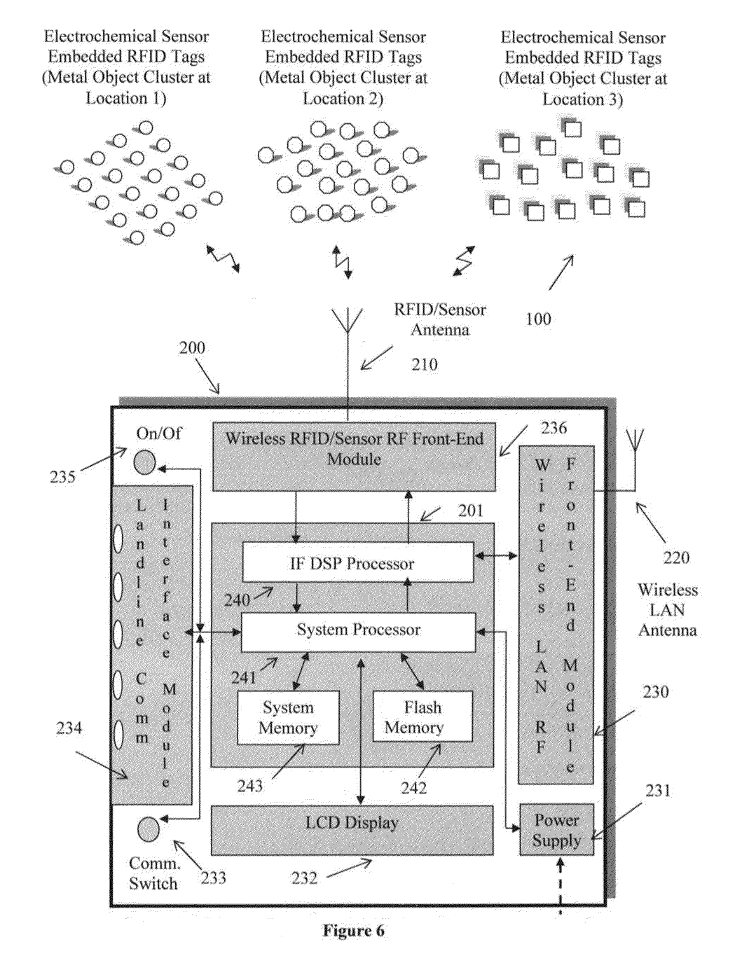

FIG. 6 shows the components of RFID Reader Apparatus 200 with Wireless LAN RF Front-End Module 230 of the electrochemical sensor embedded RFID system of this invention. Main Processing Units 201 contains System Software 300 that uses an active, real-time monitoring method to read and write data from and to Electrochemical Sensor Embedded RFID Tag Apparatus 100, and to communication with main server through either wireless LAN communication network or landline communication network. The key component of Main Processing Unit 201 is System Processor 241 which is connected to IF (Intermediate Frequency) Digital Signal Processing (DSP) Processor 240, Landline Communication Module 234, System Memory 243, Flash Memory 242, On/Off Button 235, Communication Switch 233, and Power Supply 231. Wireless RFID/Sensor RF Front-find Module 236 is responsible for converting analog signal, operating at RFID frequency spectrum, to an Intermediate Frequency (IF). Wireless LAN RF Front-End Module 230 is response for converting analog signal, operating at wireless LAN spectrum to the same Intermediate Frequency (IF) so that IF DSP Processor 340 can process it. Wireless RFID/Sensor RF Front-End Module 236 is connected to a plurality of RFID/Sensor Antenna 210, and means for conducting two-way wireless communication, with Electrochemical Sensor Embedded RFID Tag Apparatus 100. Wireless LAN RF Front-End Module 230 is connected to Wireless LAN Antenna 220, and means for conducting two-way wireless communication with the Access Point (AP) of a wireless LAN communication network.

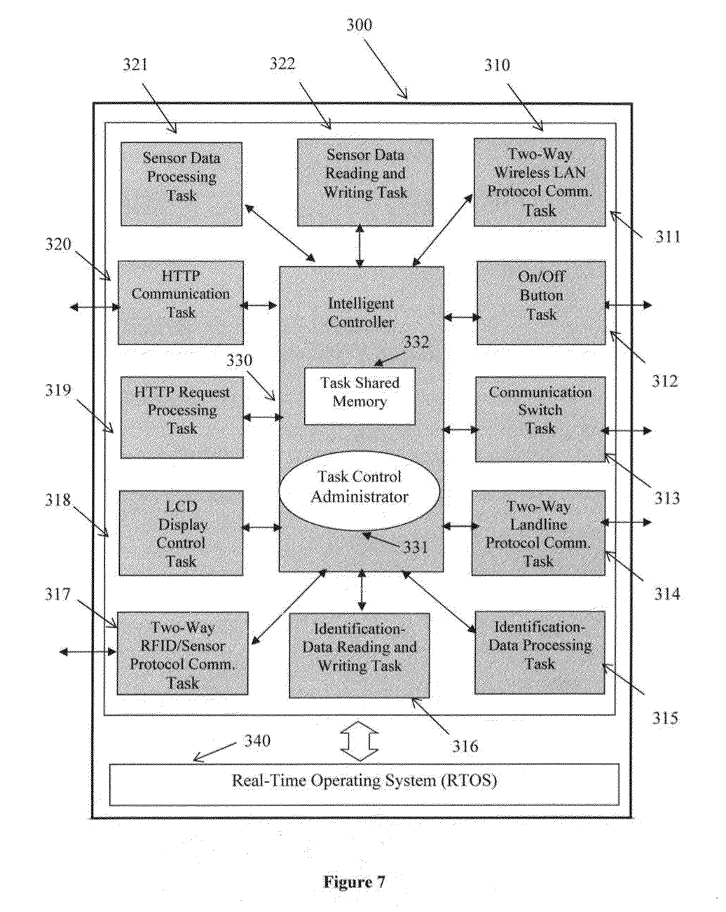

FIG. 7 shows the components of System Software 300 of the electrochemical sensor embedded RFID system of this invention. Application Tasks of System Software 300 resides in System Processor 241, and run under Real-time Operating System (RTOS) 340. System Software 300 includes Intelligent Controller 330, which comprises Task Control Administration 331, and a plurality of Task Shared Memory 332. Task Control Administrator 331 manages and controls the execution of application tasks which include Two-Way Wireless LAN Protocol Communication Task 310. On/Off Button Task 312, Communication Switch Task 313, Two-Way Landline Protocol Communication Task 314, Identification Data Processing Task 315, identification Data Reading and Writing Task 316, Two-Way RFID/Sensor Protocol Communication Task 317, LCD Display Control Task 318, HTTP Request Processing Task 319, HTTP Communication Task 320, Sensor Data Processing Task 321, and Sensor Data Reading and Writing Task 322.

### PREFERRED EMBODIMENT—OPERATION

The operation of the electrochemical sensor embedded RFID system of this invention can be described as follows. First, RFID Reader Apparatus 200 illuminates the Electrochemical Sensor Embedded RFID Tag Apparatus 100. The power incident on the Electrochemical Sensor Embedded RFID Tag Apparatus 100 is rectified to produce the DC power needed to operate the Electrochemical Sensor Embedded RFID Tag Apparatus 100 and Electrochemical Sensor Module 160. Next, Electrochemical Sensor Module 160 sends reading requests to Referencing Electrode 161 and Sensing Electrode 165 to determine sensor states. Those sensor states are then sent to Microcontroller 104 for processing. By comparing electrochemical data from Referencing Electrode 161 and Sensing Electrode 165, corrosion status of the object attached with Electrochemical Sensor Embedded RFID Tag Apparatus 100 can be determined. Next, the backscatter front the Electrochemical Sensor Embedded RFID Tag Apparatus 100 is modulated, according to the EPC (Electronic Product Code) ID code in the RFID memory. Finally, Electrochemical Sensor Embedded RFID Tag Apparatus 100 reports the EPC ID code and electrochemical sensor data, through the RFID/Sensor Antenna 140, to RFID Reader Apparatus 200 for further processing.

RFID Reader Apparatus 200 comprises anti-collision capability for processing multiple wireless RFID/sensor communication protocols. These multiple wireless RFID/sensor communication protocols might include reader-talk-first mode or tag-talk-first mode processed/communicated among RFID Reader Apparatus 200. This anti-collision capability can also have each Electrochemical Sensor Embedded RFID Tag Apparatus 100 transmit in a random time slot and have RFID Reader Apparatus 200 search in different time slots and reject multiple readings of the same tag. Since more than one Electrochemical Sensor Embedded RFID Tag Apparatus 100 may be in the interrogating held of RFID Reader Apparatus 200 at one time, this anti-collision capability allows tag collision to be avoided.

### PREFERRED EMBODIMENT—APPLICATIONS

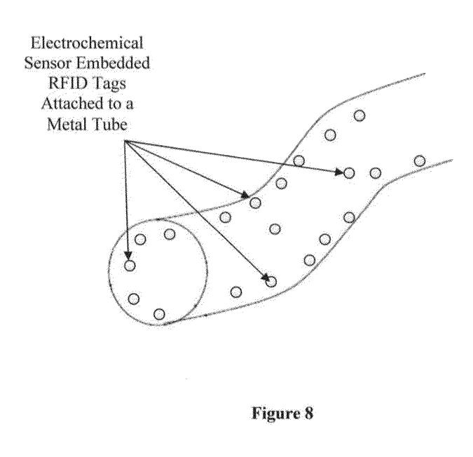

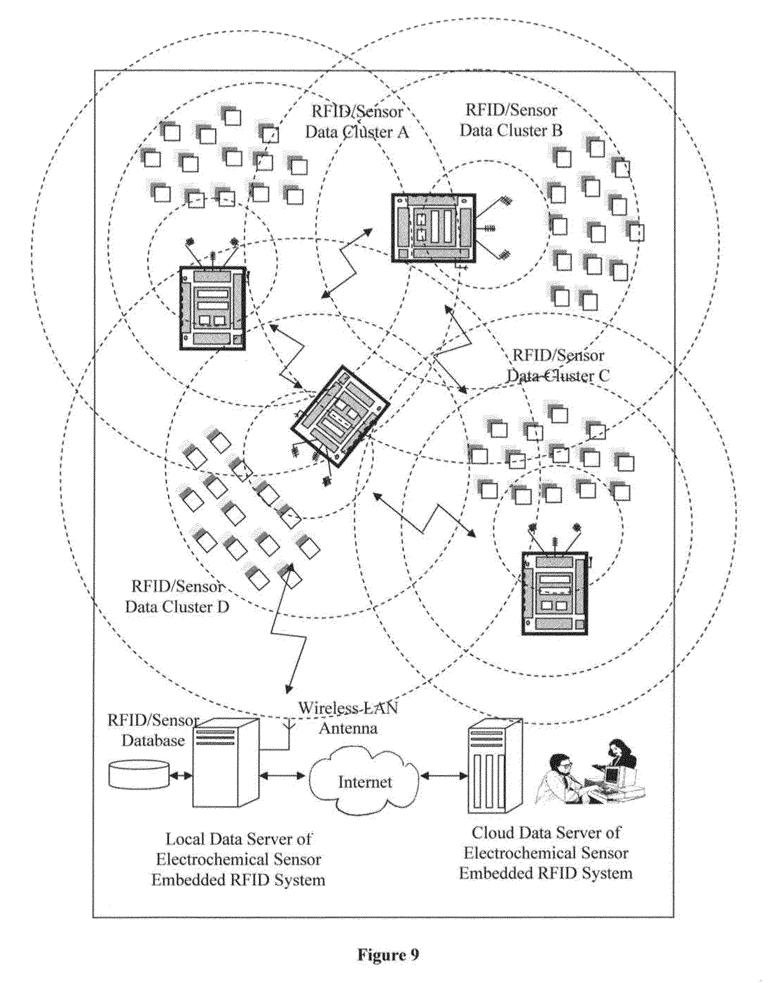

FIG. 8 shows illustrated view of metal tube attached with, a plurality of electrochemical sensor embedded RFID tag apparatus 100. There are many application configurations of the electrochemical sensor embedded RFID system of this invention. FIG. 9 shows one application view of the electrochemical sensor embedded RFID system. Each RFID/sensor data cluster can be read and monitored by multiple RFID readers. For RFID readers that are located too far from the main server of electrochemical sensor embedded RFID system, RFID/sensor data are relayed through nearest RFID reader in order to reach the main server. Two-way communication among all RFID readers allow electrochemical sensor embedded RFID tag data, read by multiple RFID readers, to be unified into a single dataset before transmitting to the main server. The electrochemical sensor embedded RFID system's main server includes 1) an intelligent RFID/sensor data monitoring and tracking system that is linked to multiple RFID readers through either landline communication connection or wireless LAN communication connection, and 2) a Web-based RFID/sensor data exchange and collaboration system that is linked to the intelligent RFID/sensor data monitoring and tracking system through Internet, Intranet or Extranet.

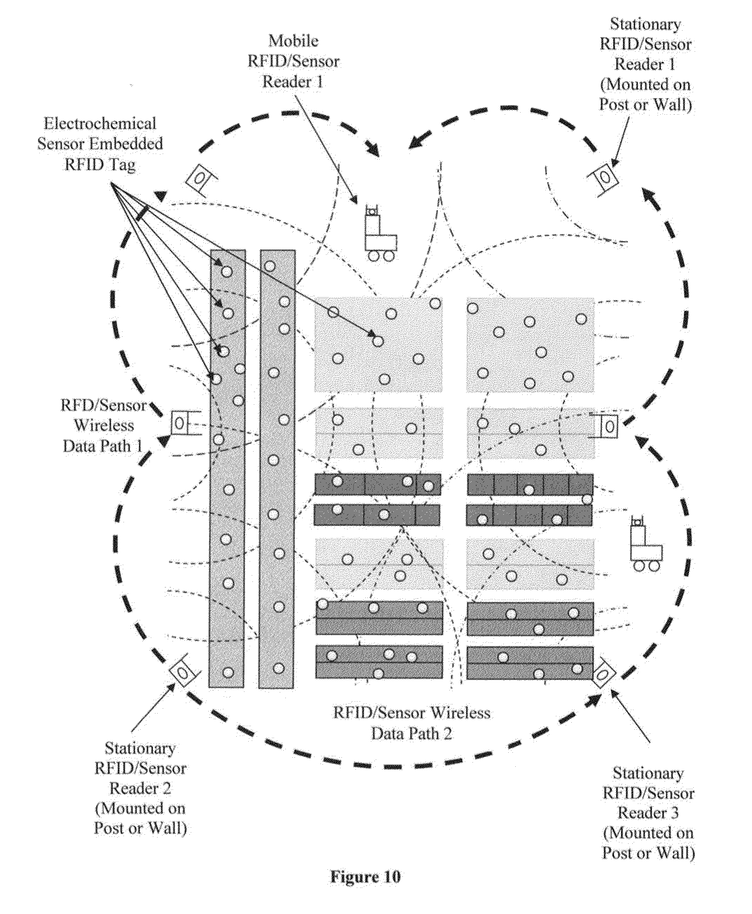

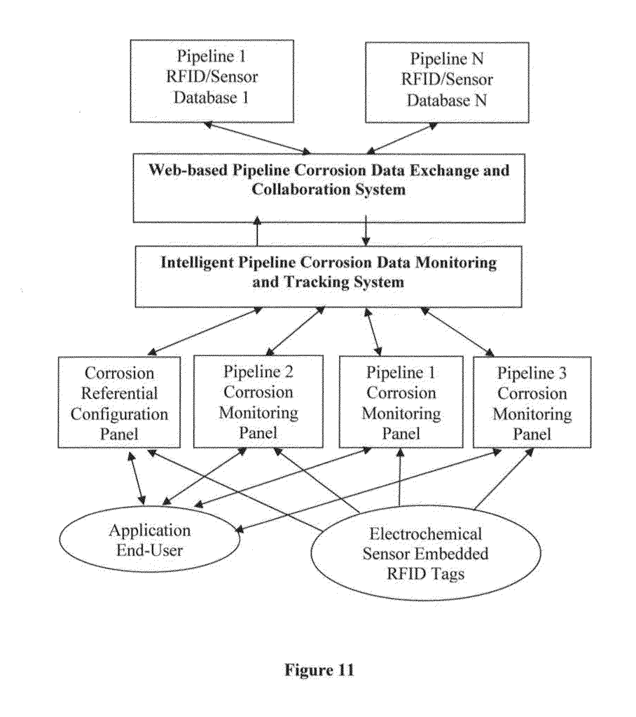

FIG. 10 shows another application view of using multiple RFID Readers of the electrochemical sensor embedded RFID system of this invention. RFID Reader is mounted on a post or a structure wall Wireless LAN access range of each RFID Reader is overlapped with other RFID readers. Through the overlapped access range, RFID/sensor data from a single electrochemical sensor embedded RFID tag is unified through two-way communication into a signal dataset first, and then relayed through multiple data path of wireless LAN to the electrochemical sensor embedded RFID system's main server at a remote location.

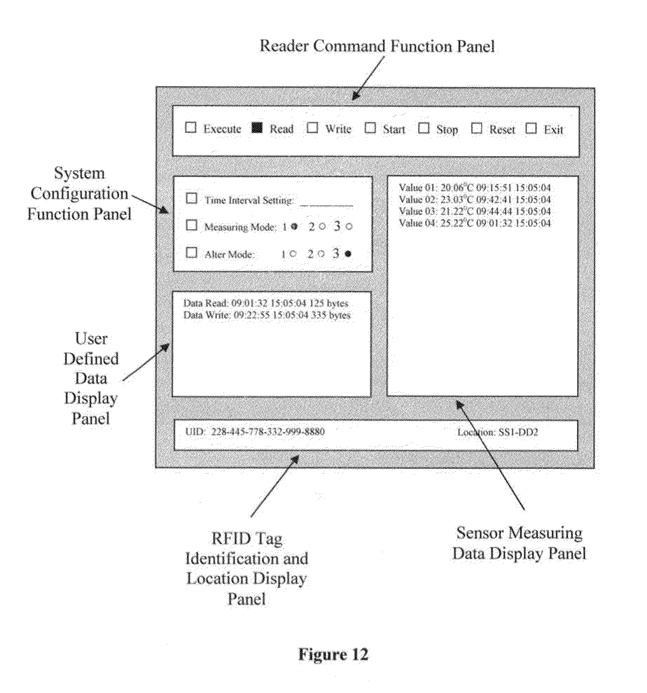

FIG. 11 shown illustrative application diagram of the intelligent RFID/sensor data monitoring and tracking system for external corrosion monitoring application of oil and natural gas pipeline of the electrochemical sensor embedded RFID system of this invention. External corrosion data acquisition and processing function of the application handles RFID and sensor data from different pipelines attached with electrochemical sensor embedded RFID tag. Corrosion data referential configuration function of the application allows end-user to specify and configure semantic relationship among all pipelines, while pipeline object configuration function of the application can be used by end-user to define detailed pipeline object information. Pipeline monitoring and tracking function allows application's end-user to monitor and control system operation. FIG. 12 illustrates the display panel of monitoring and tracking function of the intelligent RFID/sensor data monitoring and tracking system.

What is claimed are:

1. An electrochemical sensor embedded RFID system comprising of (A) a plurality of electrochemical sensor embedded RFID tag apparatus for identifying, sensing and measuring the electrochemical parameters and conditions of an object attached with the said electrochemical sensor embedded RFID tag apparatus, the said electrochemical sensor embedded RFID tag apparatus includes the circuitry of microcontroller, clock generator, ROM/EPROM memory, pulse gap detector, rectifier, power supply and storage, transducer, electrochemical, sensor module, and (B) a RFID reader apparatus, the said RFID reader apparatus has signal strength measurement capability and contains (a) the circuitry of main processing unit, wireless RFID/sensor RF front-end module, wireless LAN RF front-end module, landline communication interface module, LCD display, on/off button, communication switch, power supply, and (b) a system software, the said system software contains an intelligent controller which includes a plurality of task shared memory and a task control administrator, and the said intelligent controller uses an active real-time concurrent method to process application tasks for monitoring, tracking and networking of object's electrochemical conditions and location information to provide an alert that can be transmitted to a remote monitoring center for immediate attention, and the said application tasks include sensor data processing task, sensor data reading and writing task, two-way wireless LAN protocol communication task, Hypertext Transmission Protocol (HTTP) communication task, HTTP request processing task, on/off button task, communication switch task, two-way landline protocol communication task, LCD display control task, two-way RFID/sensor protocol communication task, identification data reading and writing task, and identification data processing task.

2. The electrochemical sensor embedded RFID tag apparatus recited in claim 1, is selected to comprise the electrochemical sensor embedded RFID tag circuitry of:
(a) a microcontroller which includes a clock divider, a modular, a transmission controller, a sensor interface, and means for processing both electrochemical sensor and RFID data,
(b) a ROM/EPROM memory, and means for storing computer programs, electrochemical sensor and RFID data,
(c) a pulse gap detector, and means for detecting signal gap,
(d) a rectifier, and means for rectifying signal gap from a RFID reader,
(e) a power supply and storage, and means for supplying power source for the said electrochemical sensor embedded RFID tag apparatus,
(f) a electrochemical sensor module, and means for detecting electrochemical parameters and conditions of objects,
(g) a clock generator, and means for generating clock signal.

3. The electrochemical sensor module as recited in claim 2, is selected to the circuitry of:
(a) a corrosion resistant RFID/sensor housing and means for protecting from corrosion object,
(b) a microcontroller, and means for processing sensor tasks,
(c) a referencing electrode that is protected by said corrosion resident RFID/sensor housing, and means for serving as a reference for electrochemical data.
(d) a plurality of transducer, and means for transducing electrochemical measurements,
(e) an Analog-to-Digital (A/D) converter, and means for converting continuous electrochemical quantity to a digital electrochemical number,
(f) a sensing electrode that is directly exposed to corrosion object outside said corrosion resistant RFID/sensor housing, and means for measurement of electrochemical data.

4. The RFID reader apparatus as recited in claim 1, is selected to comprise the mobile RFID reader apparatus with integrated wireless LAN RF front-end module circuitry of:
(a) a system processor in the said main processing unit, and means for processing digital signals, interfacing with input/output devices, and conducting system related computations,
(b) an IF DSP processor in the said main process unit, and means for processing Intermediate frequency through DSP processor from the said electrochemical sensor embedded RFID tag apparatus,
(c) a system main memory in the said main process unit, and means for using as system memory of the said main process unit,
(d) a flash memory in the said main processing unit, and means for storing data from two-way wireless communication processing, RFID and sensor related application tasks of the said main processing unit,
(e) two-way wireless communication RF front-end module, and means for receiving and transmitting wireless signals and protocols, and acquiring signal strength and time-of-arrival data from nearby transmission station.
(f) a wireless RFID/sensor RF front-end module, and means for transmitting and receiving signal from the said RFID/sensor tag apparatus,
(g) a LCD display, and means for displaying data of the said RFID reader apparatus,
(h) an on/off button, and means for turning on and off system on the said RFID reader apparatus,
(i) a communication switch, and means for switching between wireless communicating and landline communication mode,
(j) a power supply, and means for storing and supplying power source for the said RFID reader apparatus,

5. The two-way wireless communication RF front-end module as recited in (e) of claim 4, is selected to use one of the following protocol;
(a) global services for mobile (gsm) protocol,
(b) code division multiple access (cdma) protocol,
(c) general packet radio service (gprs) protocol,
(d) cellular digital packet data (cdpd) protocol,
(e) global satellite communication protocol,
(f) bluetooth protocol,
(g) wireless 802.11 protocol,
(h) wireless 802.15 protocol.

6. The RFID reader apparatus as melted in claim 1, is selected to comprise the stationary RFID reader apparatus with integrated landline communication module circuitry of:
(a) a system processor in the said main processing unit, and means for processing digital signals, interfacing with input/output devices, and conducting system related computations,
(b) an IF DSP processor in the said main process unit, and means for processing intermediate frequency through DSP processor from the said electrochemical sensor embedded RFID tag apparatus,
(c) a system main memory in the said main process unit, and means for using as system memory of the said main process unit,
(d) a flash memory in the said main processing unit, and means for storing data from, two-way wireless communication processing, RFID and sensor related application tasks of the said main processing unit,
(e) landline communication module, and means for receiving and transmitting wireline signals and protocols,
(f) a wireless RFID/sensor RF front-end module, and means for transmitting and receiving signal from the said RFID/sensor tag apparatus,
(g) a LCD display, and means for displaying data of the said RFID reader apparatus,
(h) an on/off button, and means for turning on and off system on the said RFID reader apparatus,
(i) a communication switch, and means for switching between wireless communicating and landline communication mode,
(j) a power supply, and means for storing and supplying power source for the said RFID reader apparatus.

7. The system software as recited in claim 1, comprising;
(a) a real-time operating system, and means for executing system start-up, memory configurations, input and output configurations, data file configurations, and system shutdown, of said system processor,
(b) an intelligent controller, and means for administrating and managing said related application tasks of said system processor.

8. The intelligent controller as recited in (b) of claim 7, comprising:
(a) a task control administrator, and means for administrating and managing said related application tasks,
(b) a plurality of task shared memory, and means for storing and. manipulating data entries of said related application tasks during system execution.

9. The task control administrator as recited in (a) of claim 8, comprising:
(a) a plurality of control rules, and means for describing control instructions of said related application tasks,
(b) a rule engine, and means for executing said control rules.

10. The intelligent controller as recited in (b) of claim 7 administrate and manage of said related application tasks of:
(a) a sensor data processing.
(b) a sensor data reading and writing task,
(c) a two-way wireless LAN protocol communication task,
(d) a Hypertext Transmission Protocol (HTTP) communication task,
(e) a HTTP request processing task,
(f) a on/off button task,
(g) a communication switch task,
(h) a two-way landline protocol communication task,
(i) a LCD display control task,
(j) a two-way RFID/sensor protocol communication task,
(k) an identification data reading and writing task,
(l) an identification data processing task.

11. The electrochemical sensor embedded RFID system as recited in claim 1, can measure signal strength of electrochemical sensor embedded RFID tag apparatus comprising the method of:
(a) multiple antennas attached at different positions of the said electrochemical sensor embedded RFID tag apparatus,
(b) transmitting signal to the said electrochemical sensor embedded RFID tag apparatus,
(c) measuring signal strength transmitted from the said electrochemical sensor embedded RFID tag apparatus.

12. The electrochemical sensor embedded RFID system as recited in claim 1, can process multiple wireless RFID/Sensor communication protocols among the said RFID readers apparatus and the electrochemical sensor embedded RFID tag apparatus using the said wireless RFID/sensor RF front-end module of the said RFID readers comprising the method of:
(a) using reader-talk-first tag processing mode,
(b) using tag-talk-first processing mode,
(c) using EPC (Electronic Product Code)-compatible protocol processing mode,
(d) using non-EPC compatible protocol processing mode.

13. The electrochemical sensor embedded RFID system as recited in claim 1, can provide both landline and wireless LAN communication capability comprising the method of:
(a) including the said RFID reader apparatus containing landline of USB, or RS232, RS485 communication ports,
(b) including wireless LAN RF front-end module containing of 802.11, 802.15, Bluetooth, or cellular communication network protocols,
(c) installing the stationary RFID reader apparatus at stationary location for detecting objects passing through stationary point,
(d) installing the said mobile RFID reader apparatus attached to moving vehicle or device to read the said RFID/sensor tag apparatus within the reading range of a moving path,
(e) tracking real-time location of the said RFID/sensor tag apparatus using joint operation of the said stationary RFID reader apparatus and the said mobile RFID reader apparatus,

14. The electrochemical sensor embedded RFID system as recited in claim 1, can provide multiple data reading functions comprising the method of:
(a) allowing item attached with the said electrochemical sensor embedded RFID tag apparatus to be transited in or out of multiple said RFID reader apparatus ranges,
(b) allowing item attached with the said electrochemical sensor embedded RFID tag apparatus to be read by multiple said RFID reader apparatus at single location,
(c) allowing item attached with the said electrochemical sensor embedded RFID tag apparatus to be read by multiple said RFID reader apparatus at multiple locations,
(d) being able to maintain identification and sensor information of the said electrochemical sensor embedded RFID tag apparatus in an unifying dataset.

15. The electrochemical sensor embedded RFID system as recited in claim 1, can maintain concurrent communication and data/information exchange comprising the method of:
(a) containing both wireless Web server and Web client at the said RFID reader apparatus,
(b) maintaining concurrent communication and data/information exchange among the said RFID readers apparatus and the said RFID/Sensor tags apparatus within the access range of the said RFID reader apparatus and the said wireless LAM RF front-end module,
(c) allowing the said RFID reader apparatus to be reconfigured from a remote server regarding transmitting/receiving frequencies, communication protocols, or external communication links,
(d) allowing data collected by the said RFID readers apparatus to be accessible by remote clients with a standard browser at anytime and anywhere.

16. The electrochemical sensor embedded RFID system as recited in claim 1, can provide the real-time location of the said RFID reader apparatus comprising the method of:
(a) including both the said stationary RFID reader apparatus and the said mobile RFID reader apparatus,
(b) determining the said RFID reader apparatus' location when the said RFID reader apparatus is at fixed position,
(c) determining the said RFID reader apparatus' location when the said RFID reader
apparatus is at local area mobile position, through calculating the reading of location of tags embedded on RFID reader apparatus' moving path or reference points,
(d) determining the said RFID reader's location when the said RFID reader is at wide area mobile position through triangulation of at least three Access Point (AP) or cellular communication towers.

17. The electrochemical sensor embedded RFID system as recited in claim 1, can communicate with an intelligent RFID/sensor data monitoring and location tracking system at a remote center comprising the method of:
(a) embedding the said landline communication interface module in the said RFID reader apparatus,
(b) embedding wireless LAN RF front-end modules in the said RFID reader apparatus,
(c) calculating the position of the said RFID/Sensor tag and the said RFID reader using the distance from the said RFID/sensor fag apparatus to the said RFID reader apparatus and the distance from the said RFID reader apparatus to Access Point (APs) of the said wireless LAN communication networks towers,
(d) transmitting local sensing and positing data to the said remote center.

18. The electrochemical sensor embedded RFID system as recited in claim 1, can share and exchange RFID/sensor data/information at the said, remote center comprising the method of:
(a) including Internet, Intranet, Extranet links,
(b) including Web-based RFID/Sensor data exchange and collaboration system server,
(c) allowing information to be accessed by all interest patties through standard Internet browser.
